(19) United States
(12) Patent Application Publication
(10) Pub. No.: US 2024/0134263 A1
(43) Pub. Date: Apr. 25, 2024

(54) ILLUMINATION SYSTEM AND PROJECTION DEVICE

(71) Applicant: Coretronic Corporation, Hsin-Chu (TW)

(72) Inventors: Wan-Ting Hsieh, Hsin-Chu (TW); Chun-Ju Wang, Hsin-Chu (TW)

(73) Assignee: Coretronic Corporation, Hsin-Chu (TW)

(21) Appl. No.: 18/489,007

(22) Filed: Oct. 17, 2023

(30) Foreign Application Priority Data
Oct. 18, 2022 (CN) 202211277964.1

(51) Int. Cl. G03B 21/20; G02B 26/00

(52) U.S. Cl. CPC G03B 21/208; G02B 26/008; G03B 21/2013; G03B 21/2033; G03B 21/206; G03B 21/2066

(57) ABSTRACT

An illumination system including a plurality of light-emitting elements, a light combining module, a first lens group, a second lens group and a wavelength conversion device is provided. The plurality of light-emitting elements provide a plurality of first light beams. The light combining module is used for combining the plurality of first light beams into a second light beam. The wavelength conversion device is used for converting the second light beam into the third light beam or reflecting the second light beam. The first lens group has a first central axis. The first lens group includes a first part and a second part which are symmetrical with respect to the first central axis and have equal areas, and a luminous flux of the second light beam passing through the first part is greater than a luminous flux passing through the second part.

### CROSS-REFERENCE TO RELATED APPLICATION

This application claims the priority benefit of China application serial no. 202211277964.1, filed on Oct. 19, 2022. The entirety of the above-mentioned patent application is hereby incorporated by reference herein and made a part of this specification.

### BACKGROUND

### Technical Field

The disclosure relates to an optical system and an electronic device, and particularly relates to an illumination system and a projection device.

### Description of Related Art

Projection device is a display device for producing a large-scale image, and has been continuously improved along with evolution and innovation of technology. An imaging principle of the projection device is to convert an illumination light beam generated by an illumination system into an image light beam through a light valve, and then project the image light beam to a projection target (such as a screen or a wall) through a projection lens to form a projection image. In addition, the illumination system has also evolved from ultra-high-performance lamp (UHP lamp), light-emitting diode (LED) to the most advanced laser diode (LD) light source, and even all-in-one laser diode packaged light sources along with requirements of the market on brightness, color saturation, service life, non-toxicity and environmental protection of the projection device.

However, in a framework of the all-in-one laser diode packaged light source, since a spacing of each light spot becomes larger, when the light spots of a plurality of different light sources are stacked, poor imaging phenomena such as non-uniformity or asymmetry may occur. In this case, conversion efficiency of a wavelength conversion device is reduced, resulting in difficulty in optimization, and it is required to configure additional lenses or increase a volume for improvement.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure is directed to an illumination system and a projection device, which are adapted to improve conversion efficiency of a wavelength conversion device.

Other objects and advantages of the disclosure may be further illustrated by the technical features broadly embodied and described as follows.

In order to achieve one or a portion of or all of the objects or other objects, an embodiment of the disclosure provides an illumination system adapted to provide an illumination light beam. The illumination system includes a plurality of light-emitting elements, a light combining module, a first lens group, a second lens group and a wavelength conversion device. Where, the plurality of light-emitting elements provide a plurality of first light beams. The light combining module is disposed on a transmission path of the plurality of first light beams, and is used for combining the plurality of first light beams into a second light beam. The first lens group is disposed on a transmission path of the second light beam for focusing and collimating the second light beam. The first lens group includes at least one lens. The second lens group is disposed on the transmission path of the second light beam coming from the first lens group. The first lens group is located between the light combining module and the second lens group. The second lens group includes at least one lens. The wavelength conversion device is disposed on the transmission path of the second light beam coming from the second lens group, and is used for converting the second light beam into a third light beam or reflecting the second light beam. The illumination light beam includes at least one of the third light beam and the second light beam. Where, the first lens group has a first central axis. The first lens group includes a first part and a second part which are symmetrical with respect to the first central axis and have equal areas, and a luminous flux of the second light beam passing through the first part is greater than a luminous flux passing through the second part.

In order to achieve one or a portion of or all of the objects or other objects, an embodiment of the disclosure provides a projection device including an illumination system, at least one light valve and a projection lens. The illumination system is adapted to provide an illumination light beam. The illumination system includes a plurality of light-emitting elements, a light combining module, a first lens group, a second lens group and a wavelength conversion device. Where, the plurality of light-emitting elements provide a plurality of first light beams. The light combining module is disposed on a transmission path of the plurality of first light beams, and is used for combining the plurality of first light beams into a second light beam. The first lens group is disposed on a transmission path of the second light beam for focusing and collimating the second light beam. The first lens group includes at least one lens. The second lens group is disposed on the transmission path of the second light beam coming from the first lens group. The first lens group is located between the light combining module and the second lens group. The second lens group includes at least one lens. The wavelength conversion device is disposed on the transmission path of the second light beam coming from the second lens group, and is used for converting the second light beam into a third light beam or reflecting the second light beam. The illumination light beam includes at least one of the third light beam and the second light beam. The at least one light valve is disposed on a transmission path of the illumination light beam for converting the illumination light beam into an image light beam. The projection lens is disposed on a transmission path of the image light beam, and is used for projecting the image light beam out of the projection device. Where, the first lens group has a first central axis. The first lens group includes a first part and a second part which are symmetrical with respect to the first central axis and have equal areas, and a luminous flux of the second light beam passing through the first part is greater than a luminous flux passing through the second part.

Based on the above description, the embodiments of the disclosure have at least one of following advantages or effects. In the illumination system and projection device of the disclosure, the multiple light-emitting elements provide multiple first light beams, and the light combining module is configured to combine the multiple first light beams into the second light beam. The first lens group is disposed on the transmission path of the second light beam to focus and collimate the second light beam, where the first lens group has a first central axis, and the first lens group includes the first part and the second part that are symmetrical with respect to the first central axis and have equal areas, and the luminous flux of the second light beam passing through the first part is greater than the luminous flux passing through the second part. In this way, based on the above-mentioned configuration and optical path design method, a more symmetrical light spot may be obtained and the conversion efficiency of the wavelength conversion device may be improved while maintaining a same volume without increasing the number of lenses. In addition, the use of all-in-one packaged laser diodes for the light-emitting elements may further reduce the volume of the light source, thereby reducing a space occupied by the light combining module.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a projection device according to an embodiment of the disclosure.

FIG. 2 and FIG. 3 are respectively a schematic side view and a schematic front view of an illumination system according to an embodiment of the disclosure.

FIG. 2A to FIG. 2C are schematic side views of first lens groups of illumination systems according to different embodiments.

FIG. 4 illustrates optical simulation diagrams of light spots of light beams of different illumination systems on a wavelength conversion device.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

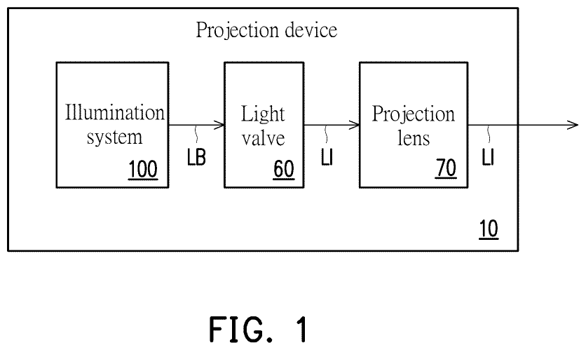

FIG. 1 is a schematic diagram of a projection device according to an embodiment of the disclosure. Referring to FIG. 1, the embodiment provides a projection device 10 including an illumination system 100, at least one light valve 60 and a projection lens 70. Wherein, the illumination system 100 is used for providing an illumination light beam LB. The at least one light valve 60 is disposed on a transmission path of the illumination light beam LB for converting the illumination light beam LB into an image light beam LI. The conversion here refers to converting the illumination light beam LB of pure color light into the image light beam LI carrying image information. The projection lens 70 is disposed on a transmission path of the image light beam LI, and is used to project the image light beam LI out of the projection device 10 to a projection target (not shown), such as a screen or a wall.

The light valve 60 is, for example, a reflective light modulator such as a liquid crystal on silicon panel (LCoS panel) or a digital micro-mirror device (DMD). In some embodiments, the light valve 60 may also be a transmissive light modulator such as a liquid crystal panel, an electro-optical modulator, a magneto-optic modulator, an acousto-optic modulator (AOM), etc. The disclosure does not limit the pattern and type of the light valve 60. Detailed steps and implementation of the method that the light valve 60 converts the illumination light beam LB into the image light beam LI may be adequately taught, suggested and implemented by the general knowledge in the related technical field, and thus will not be repeated here. In the embodiment, the number of the light valves 60 is one, for example, only a single digital micro-mirror device is used in the projection device 10, but in other embodiments, multiple light valves may also be used, which is not limited by the disclosure.

The projection lens 70 includes, for example, a combination of one or more optical lenses having diopters, such as various combinations of non-planar lenses such as a biconcave lens, a biconvex lens, a concavo-convex lens, a convexo-concave lens, a plano-convex lens, a plano-concave lens, etc. In an embodiment, the projection lens 70 may further include a planar optical lens, which projects the image light beam LI coming from the light valve 60 to the projection target in a reflective manner. The disclosure does not limit the pattern and type of the projection lens 70.

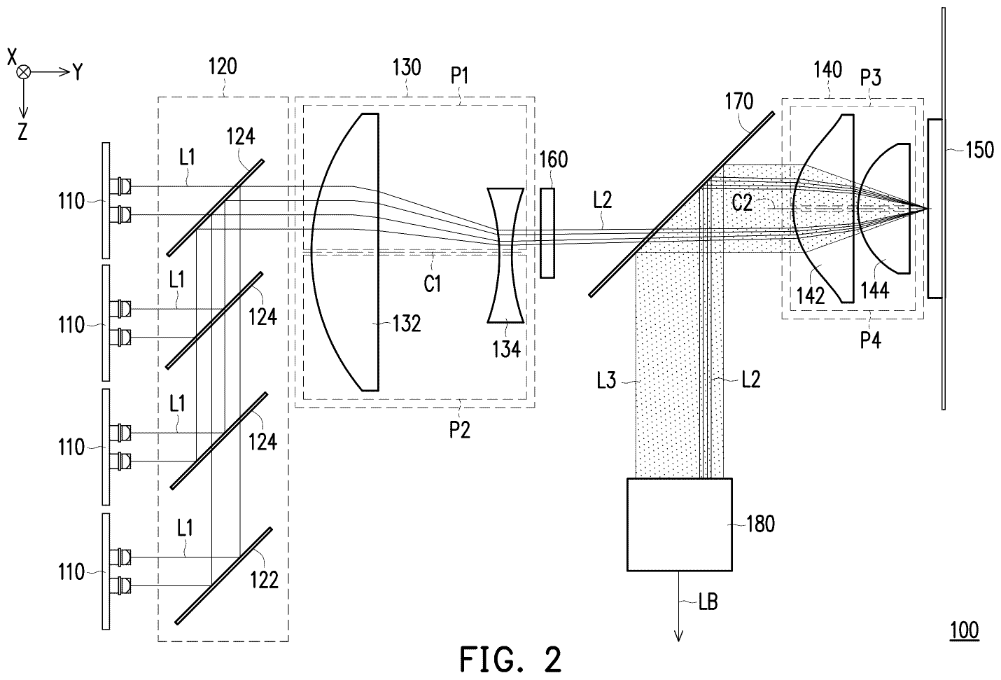

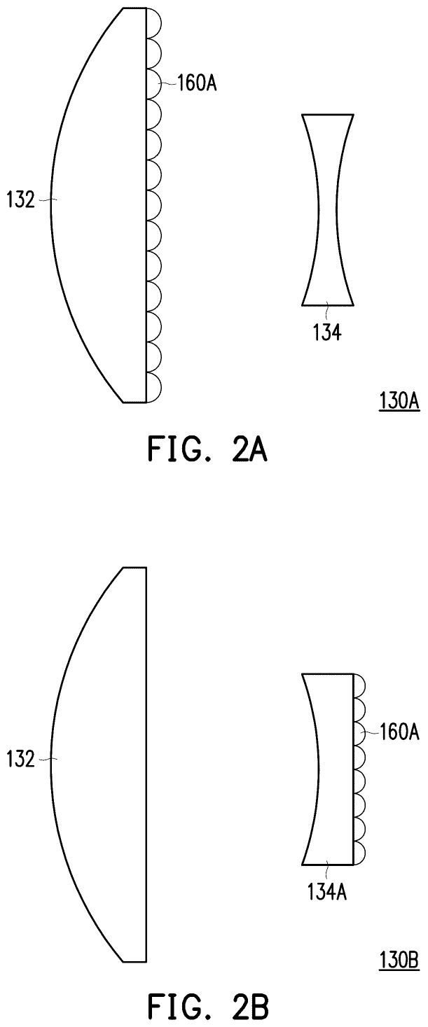

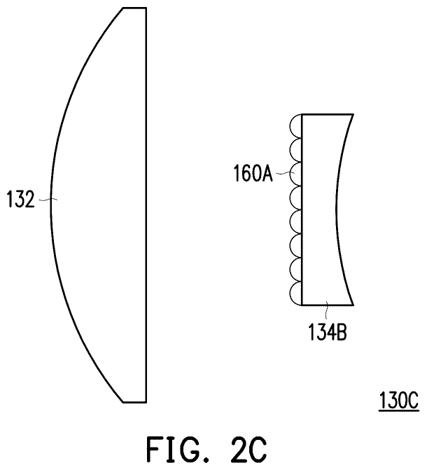

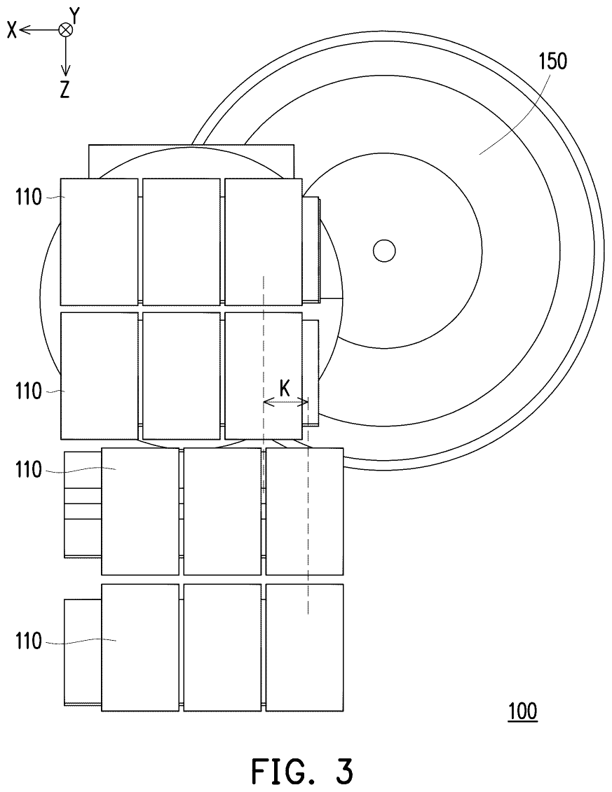

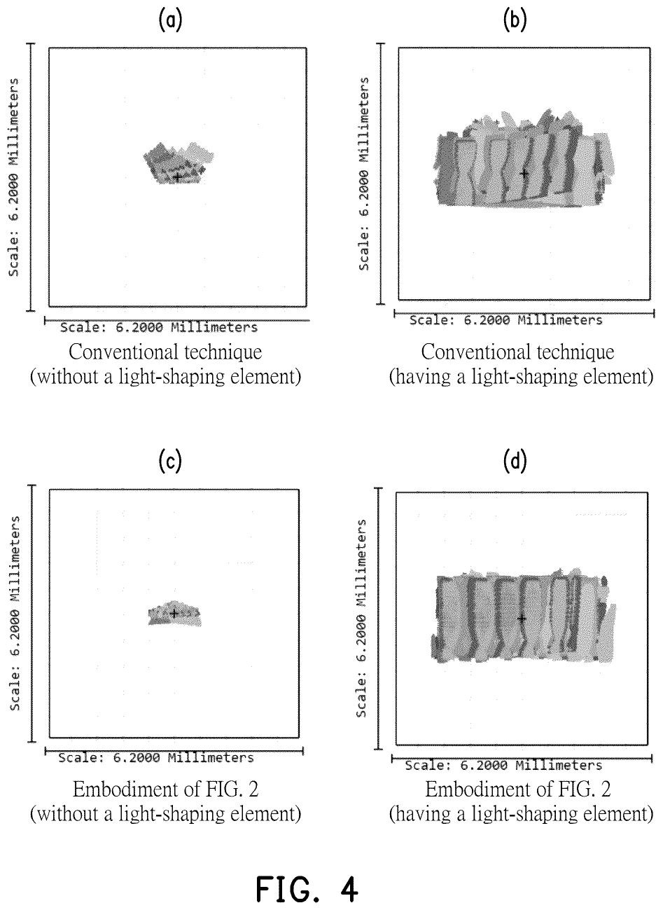

FIG. 2 and FIG. 3 are respectively a schematic side view and a schematic front view of an illumination system according to an embodiment of the disclosure. Referring to FIG. 2 and FIG. 3, the illumination system 100 includes a plurality of light-emitting elements 110, a light combining module 120, a first lens group 130, a second lens group 140 and a wavelength conversion device 150. Where, the plurality of light-emitting elements 110 provide a plurality of first light beams L1. In the embodiment, the plurality of light-emitting elements 110 are all-in-one packaged laser diodes, and the plurality of first light beams L1 are blue light beams. Wavelengths of the plurality of first light beams L1 may be the same or approximately the same (a maximum difference in the wavelengths of the plurality of first light beams L1 is less than 25 nm), for example, the blue all-in-one packaged laser diodes with the wavelengths of 445 nm, 448 nm, 455 nm or 465 nm. For example, the light-emitting elements 110 may adopt twelve ten-in-one packaged blue-light laser diodes (i.e., one light-emitting element 110 has ten light-emitting chips), which are arrange in an array, where eight packaged blue-light laser diodes have an emission wavelength of 455 nm, and the other four packaged blue laser diodes have an emission wavelength of 448 nm. In terms of an arrangement position, in the embodiment, the twelve light-emitting elements 110 are arranged in an array of 3×4, and are divided into two groups with six light-emitting elements 110 in one group, and the two groups are misaligned in a single direction to form a displacement K between the two groups of the light-emitting elements 110, as shown in FIG. 3. In this way, configuration convenience of the light combining module 120 is improved, and space utilization efficiency of a heat dissipation structure used for the plurality of light-emitting elements 110 may be improved, but the disclosure is not limited thereto.

The light combining module 120 is disposed on a transmission path of the plurality of first light beams L1. Specifically, the light-combining module 120 is disposed on the transmission path of the plurality of first light beams L1 coming from the plurality of light-emitting elements 110. The light combining module 120 is used to combine the plurality of first light beams L1 into a second light beam L2. In detail, the light combining module 120 includes at least one reflector 122, at least one beam splitter 124 or a combination thereof. Namely, a quantity and type of the reflector 122 and the beam splitters 124 may be designed according to a quantity of the light-emitting elements 110 and a space of the illumination system 100, which is not limited by the disclosure. For example, in the embodiment, the light combining module 120 includes one reflector 122 and three beam splitters 124, where the reflector 122 is disposed on the transmission path of the first light beam L1 provided by the light-emitting element 110 farthest from the second light beam L2 (there are actually three light-emitting elements 110 in an X-axis direction of FIG. 2, so that there are also three light-emitting elements 110 corresponding to each beam splitter 124 in FIG. 2) for reflecting the first light beam L1 to one of the beam splitters 124. The three beam splitters 124 are respectively arranged on the transmission paths of the plurality of first light beams L1 provided by the other nine (each beam splitter 124 is configured with three) light-emitting elements 110, so as to combine the plurality of first light beams L1, as shown in FIG. 2. In different configurations of the same embodiment, the reflector 122 may also be replaced by the beam splitter 124, but the disclosure is not limited thereto.

The first lens group 130 is disposed on the transmission path of the second light beam L2 for focusing and collimating the second light beam L2. Specifically, the first lens group 130 is disposed on the transmission path of the second light beam L2 coming from the light combining module 120. The first lens group 130 includes at least one lens. In detail, in the embodiment, the first lens group 130 includes a first focusing lens 132 and a first collimating lens 134, and the first focusing lens 132 is located between the light combining module 120 and the first collimating lens 134. The first focusing lens 132 is configured to focus the second light beam L2, and the first collimating lens 134 is configured to collimate the second light beam L2. However, in different embodiments, the first lens group 130 may only include a single lens for focusing and collimating the second light beam L2 at the same time, which is not limited by the disclosure.

The first lens group 130 may be defined to include a first part P1 and a second part P2. Specifically, the first lens group 130 has a first central axis C1 passing through a center of an optical effective area of the first lens group 130, and the first lens group 130 includes the first part P1 and the second part P2 which are symmetrical with respect to the first central axis C1 (or through the first central axis C1) and have equal areas. It should be noted that a luminous flux of the second light beam L2 from the light combining module 120 passing through the first part P1 is greater than a luminous flux thereof passing through the second part P2. For example, in the embodiment, the second light beam L2 coming from the light combining module 120 only passes through the first part P1 of the first lens group 130, as shown in FIG. 2. Namely, in the embodiment, an optical axis of the second light beam L2 does not overlap with the first central axis C1 of the first lens group 130. Therefore, the second light beam L2 is incident to the first lens group 130 in an off-axis manner.

In the embodiment, the illumination system 100 further includes a light-shaping element 160 disposed between the first lens group 130 and the second lens group 140. Specifically, the light-shaping element 160 is disposed on the transmission path of the second light beam L2 coming from the first lens group 130. The light-shaping element 160 is configured to adjust a light shape of the second light beam L2, so that the light shape of the second light beam L2 is more suitable for subsequent optical elements. For example, the light-shaping element 160 is, for example, a fly eye lens array, a diffuser or a prism, but the disclosure is not limited thereto.

FIG. 2A to FIG. 2C are schematic side views of the first lens groups of the illumination systems according to different embodiments. Referring to FIG. 2A to FIG. 2C, as explained in the previous paragraph, in some different embodiments, the light-shaping element 160 may be integrated into one of the lenses in the first lens group 130, for example, connected through adhering as shown in the figure, or the light-shaping element 160 and one of the lenses in the first lens group 130 are directly formed integrally, but the disclosure is not limited thereto. In this way, a space saving effect may be achieved. For example, in a first lens group 130A shown in FIG. 2A, the first focusing lens 132 is a convex-planar optical lens, and a light-shaping element 160A is, for example, connected to the planar surface of the first focusing lens 132 in the first lens group 130 in the form of a lens array. For another example, in a first lens group 130B shown in FIG. 2B, a first collimating lens 134A is a concave-planar optical lens, and the light-shaping element 160A is, for example, connected to the planar surface of the first collimating lens 134A in the form of a lens array. For another example, in a first lens group 130C shown in FIG. 2C, a first collimating lens 134B is a plano-concave optical lens, and the light-shaping element 160A is, for example, connected to the planar surface of the first collimating lens 134B in the form of a lens array.

Referring to FIG. 2 again, the second lens group 140 is disposed on the transmission path of the second light beam L2, and the first lens group 130 is located between the light combining module 120 and the second lens group 140. Specifically, the second lens group 140 is arranged on the transmission path of the second light beam L2 coming from the first lens group 130. The second lens group 140 includes at least one lens. In detail, in the embodiment, the second lens group 140 includes a second focusing lens 142 and a third focusing lens 144, and the second focusing lens 142 is located between the first lens group 130 and the third focusing lens 144. The second focusing lens 142 and the third focusing lens 144 are configured to focus the second light beam L2 onto the wavelength conversion device 150. However, in different embodiments, the second lens group 140 may only include a single lens, which is not limited by the disclosure.

The second lens group 140 may be defined to include a third part P3 and a fourth part P4. Specifically, the second lens group 140 has a second central axis C2 passing through a center of an optical effective area of the second lens group 140, and the second lens group 140 includes the third part P3 and the fourth part P4 which are symmetrical with respect to the second central axis C2 (or through the second central axis C1) and have equal areas. It should be noted that a luminous flux of the second light beam L2 from the first lens group 130 passing through the fourth part P4 is greater than a luminous flux thereof passing through the third part P3. For example, in the embodiment, the second light beam L2 coming from the light-shaping element 160 only passes through the fourth part P4 of the second lens group 140, as shown in FIG. 2. Namely, in the embodiment, an optical axis of the second light beam L2 does not overlap with the second central axis C1 of the second lens group 140. Therefore, the second light beam L2 is incident to the second lens group 140 in the off-axis manner. In the embodiment, positions of the first part P1 and the second part P2 of the first lens group 130 correspond to the third part P3 and the fourth part P4 of the second lens group 140. However, in different embodiments, the positions of the third part P3 and the fourth part P4 may also be exchanged, so that the position of the first part P1 of the first lens group 130 corresponds to the fourth part P4 of the second lens group 140, and the position of the second part P2 of the first lens group 130 corresponds to the third part P3 of the second lens group 140, but the disclosure is not limited thereto.

The wavelength conversion device 150 is disposed on the transmission path of the second light beam L2, and is configured to convert the second light beam L2 into a third light beam L3 or reflect the second light beam L2. The conversion here refers to the conversion of the blue second light beam L2 into the yellow/green/orange third light beam L3. Specifically, the wavelength conversion device 150 is disposed on the transmission path of the second light beam L2 coming from the second lens group 140. For example, the wavelength conversion device 150 is, for example, an annular and rotatable color wheel device, and includes at least one conversion area for converting the second light beam L2 and a reflection area for reflecting the second light beam L2, where the conversion area and the reflection area are distributed on an annular substrate in different ratios/same ratio. When the illumination system 100 is activated, the second light beam L2 is transmitted to the conversion area or the reflection area of the wavelength conversion device 150 according to different timings to generate the third light beam L3, or the second light beam L2 is reflected. In other words, the illumination light beam LB includes at least one of the third light beam L3 and the second light beam L2. However, the disclosure does not limit the type or form of the wavelength conversion device 150, and a detailed structure and implementation thereof may be adequately taught, suggested, and implemented by common knowledge in the related technical field, and thus will not be repeated here.

Since the second light beam L2 is incident to the second lens group 140 in the off-axis manner, the second light beam L2 passing through the second lens group 140 will also be incident to the wavelength conversion device 150 in the off-axis manner, and the second lens group 140 receives the second light beam L2 from the wavelength conversion device 150 at a symmetrical position relative to the above light beam while taking the second central axis C2 as a symmetrical center, as shown in FIG. 2. Namely, the second light beam L2 is incident to the wavelength conversion device 150 from the fourth part P4 of the second lens group 140, and the third part P3 of the second lens group 140 receives the second light beam L2 from the wavelength conversion device 150. Since the third light beam L3 has a larger light divergence angle, both of the third part P3 and the fourth part P4 of the second lens group 140 receive the third light beam L3 from the wavelength conversion device 150.

In the embodiment, the illumination system 100 further includes a dichroic element 170 and a light homogenizing element 180. The dichroic element 170 is arranged on the transmission path of the second light beam L2 and the third light beam L3, and allows the second light beam L2 from the first lens group 130 to pass through and reflect the second light beam L2 and the third light beam L3 from the second lens group 140. The light homogenizing element 180 is disposed on the transmission path of the second light beam L2 and the third light beam L3 from the dichroic element 170 to homogenize the second light beam L2 and the third light beam L3 from the dichroic element 170. For example, in the embodiment, the dichroic element 170 has, for example, a first area and a second area (not shown), where the first area has a blue-transmitting coating, the second area has a blue-reflecting coating, and both of the first area and the second area have a yellow/green/orange-reflecting coating, so that the second light beam L2 from the first lens group 130 passes through the second lens group 140 through the first area, and the second light beam L2 from the second lens group 140 is reflected to the light homogenizing element 180 by the second area, and the third light beam L3 from the second lens group 140 is commonly reflected to the light homogenizing element 180 by the first area and the second area. The light homogenizing element 180 is, for example, an integrating rod, and is configured to adjust a light spot shape of the illumination light beam LB. However, in other embodiments, the light homogenizing element 180 may also be an optical element of other suitable types, such as a lens array, which is not limited by the disclosure.

FIG. 4 illustrates optical simulation diagrams of light spots of light beams of different illumination systems on the wavelength conversion device. Referring to FIG. 2 and FIG. 4, in FIG. 4, the optical simulation diagrams shown in (a) to (d) are respectively light spots formed by the light beams falling on the wavelength conversion device in different embodiments. As described in the previous paragraph, based on the above configuration and optical path design, since the luminous flux of the second light beam L2 passing through the first part P1 of the first lens group 130 is greater than the luminous flux thereof passing through the second part P2, a more symmetrical light spot may be obtained and the conversion efficiency of the wavelength conversion device may be improved while maintaining a same volume without increasing the number of lenses. To be specific, a part (a) in FIG. 4 shows a light spot of an illumination system using conventional technology without a light-shaping element, a part (b) in FIG. 4 shows a light spot of an illumination system using conventional technology and having a light-shaping element, and a part (c) of FIG. 4 shows a light spot of an illumination system using the technology of FIG. 2 without a light-shaping element, and a part (d) of FIG. 4 shows a light spot of an illumination system using the technology of FIG. 2 and having a light-shaping element. By comparing the optical simulation diagrams (a) to (d) of FIG. 4, it is learned that in the illumination system using the technology of the disclosure, the shape of the light spot on the wavelength conversion device is relatively neat and has better symmetry, and energy distribution thereof is more uniform. In addition, the use of an all-in-one packaged laser diode for the light-emitting element 110 may further reduce a volume of the light source, thereby reducing the space occupied by the light combining module 120.

In summary, in the illumination system and projection device of the disclosure, the multiple light-emitting elements provide multiple first light beams, and the light combining module is configured to combine the multiple first light beams into the second light beam. The first lens group is disposed on the transmission path of the second light beam to focus and collimate the second light beam, where the first lens group has a first central axis, and the first lens group includes the first part and the second part that are symmetrical with respect to the first central axis and have equal areas, and the luminous flux of the second light beam passing through the first part is greater than the luminous flux passing through the second part. In this way, based on the above-mentioned configuration and optical path design method, a more symmetrical light spot may be obtained and the conversion efficiency of the wavelength conversion device may be improved while maintaining a same volume without increasing the number of lenses. In addition, the use of all-in-one packaged laser diodes for the light-emitting elements may further reduce the volume of the light source, thereby reducing a space occupied by the light combining module.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. An illumination system, adapted to provide an illumination light beam, and the illumination system comprising a plurality of light-emitting elements, a light combining module, a first lens group, a second lens group and a wavelength conversion device, wherein:
the plurality of light-emitting elements provide a plurality of first light beams;
the light combining module is disposed on a transmission path of the plurality of first light beams, and is used for combining the plurality of first light beams into a second light beam;
the first lens group is disposed on a transmission path of the second light beam for focusing and collimating the second light beam, and the first lens group comprises at least one lens;
the second lens group is disposed on the transmission path of the second light beam coming from the first lens group, the first lens group is located between the light combining module and the second lens group, and the second lens group comprises at least one lens; and
the wavelength conversion device is disposed on the transmission path of the second light beam coming from the second lens group, and is used for converting the second light beam into a third light beam or reflecting the second light beam, and the illumination light beam comprises at least one of the third light beam and the second light beam, wherein the first lens group has a first central axis, the first lens group comprises a first part and a second part which are symmetrical with respect to the first central axis and have equal areas, and a luminous flux of the second light beam passing through the first part is greater than a luminous flux passing through the second part.

2. The illumination system as claimed in claim 1, wherein the second light beam only passes through the first part.

3. The illumination system as claimed in claim 1, wherein the second lens group has a second central axis, and the second lens group comprises a third part and a fourth part that are symmetrical with respect to the second central axis and have equal areas, and a luminous flux of the second light beam coming from the first lens group and passing through the fourth part is greater than a luminous flux passing through the third part.

4. The illumination system as claimed in claim 3, wherein the second light beam from the first lens group only passes through the fourth part.

5. The illumination system as claimed in claim 1, wherein each of the plurality of light-emitting elements is an all-in-one packaged laser diode, and the plurality of first light beams are blue light beams.

6. The illumination system as claimed in claim 1, wherein the light combining module comprises at least one reflector, at least one beam splitter or a combination thereof.

7. The illumination system as claimed in claim 1, wherein the illumination system further comprises a light-shaping element disposed on the transmission path of the second light beam for adjusting a light shape of the second light beam.

8. The illumination system as claimed in claim 7, wherein the light-shaping element is integrated on the at least one lens of the first lens group.

9. The illumination system as claimed in claim 1, wherein an optical axis of the second light beam does not overlap with the first central axis of the first lens group.

10. The illumination system as claimed in claim 1, wherein the first lens group includes a first focusing lens and a first collimating lens, the first focusing lens is located between the light combining module and the first collimating lens, the first focusing lens is used for focusing the second light beam, and the first collimating lens is used for collimating the second light beam.

11. The illumination system as claimed in claim 1, further comprising a dichroic element and a light homogenizing element, wherein the dichroic element is disposed on transmission paths of the second light beam and the third light beam to allow the second light beam from the first lens group to pass through and reflect the second light beam and the third light beam from the second lens group, and the light homogenizing element is disposed on the transmission paths of the second light beam and the third light beam from the dichroic element for homogenizing the second light beam and the third light beam.

12. A projection device, comprising an illumination system, at least one light valve and a projection lens, wherein:
the illumination system is adapted to provide an illumination light beam, and the illumination system comprises a plurality of light-emitting elements, a light combining module, a first lens group, a second lens group and a wavelength conversion device, wherein:
the plurality of light-emitting elements provide a plurality of first light beams;
the light combining module is disposed on a transmission path of the plurality of first light beams, and is used for combining the plurality of first light beams into a second light beam;
the first lens group is disposed on a transmission path of the second light beam for focusing and collimating the second light beam, and the first lens group comprises at least one lens;
the second lens group is disposed on the transmission path of the second light beam coming from the first lens group, the first lens group is located between the light combining module and the second lens group, and the second lens group comprises at least one lens; and
the wavelength conversion device is disposed on the transmission path of the second light beam coming from the second lens group, and is used for converting the second light beam into a third light beam or reflecting the second light beam, and the illumination light beam comprises at least one of the third light beam and the second light beam;
the at least one light valve is disposed on a transmission path of the illumination light beam for converting the illumination light beam into an image light beam; and
the projection lens is disposed on a transmission path of the image light beam, and is used for projecting the image light beam out of the projection device, wherein the first lens group has a first central axis, the first lens group comprises a first part and a second part which are symmetrical with respect to the first central axis and have equal areas, and a luminous flux of the second light beam passing through the first part is greater than a luminous flux passing through the second part.

13. The projection device as claimed in claim 12, wherein the second light beam only passes through the first part.

14. The projection device as claimed in claim 12, wherein the second lens group has a second central axis, and the second lens group comprises a third part and a fourth part that are symmetrical with respect to the second central axis and have equal areas, and a luminous flux of the second light beam coming from the first lens group and passing through the fourth part is greater than a luminous flux passing through the third part.

15. The projection device as claimed in claim 14, wherein the second light beam from the first lens group only passes through the fourth part.

16. The projection device as claimed in claim 12, wherein each of the plurality of light-emitting elements is an all-in-one packaged laser diode, and the plurality of first light beams are blue light beams.

17. The projection device as claimed in claim 12, wherein the light combining module comprises at least one reflector, at least one beam splitter or a combination thereof.

18. The projection device as claimed in claim 12, wherein the illumination system further comprises a light-shaping element disposed on the transmission path of the second light beam for adjusting a light shape of the second light beam.

19. The projection device as claimed in claim 18, wherein the light-shaping element is integrated on the at least one lens of the first lens group.

20. The projection device as claimed in claim 12, wherein an optical axis of the second light beam does not overlap with the first central axis of the first lens group.

21. The projection device as claimed in claim 12, wherein the first lens group comprises a first focusing lens and a first collimating lens, the first focusing lens is located between the light combining module and the first collimating lens, the first focusing lens is used for focusing the second light beam, and the first collimating lens is used for collimating the second light beam.

22. The projection device as claimed in claim 12, wherein the illumination system further comprises a dichroic element and a light homogenizing element, the dichroic element is disposed on transmission paths of the second light beam and the third light beam to allow the second light beam from the first lens group to pass through and reflect the second light beam and the third light beam from the second lens group, and the light homogenizing element is disposed on the transmission paths of the second light beam and the third light beam from the dichroic element for homogenizing the second light beam and the third light beam.
